(19) United States
(12) Patent Application Publication
(10) Pub. No.: US 2026/0303495 A1
(43) Pub. Date: Oct. 1, 2026

(54) PROGRAMMABLE REMOTE DIRECT MEMORY ACCESS METRICS FROM NETWORK DEVICES

(71) Applicant: Cisco Technology, Inc., San Jose, CA (US)

(72) Inventors: Harsha Bharadwaj, Bilekahalli (IN); Melvin M. Tsai, Palo Alto, CA (US)

(21) Appl. No.: 19/092,760

(22) Filed: Mar. 27, 2025

(51) Int. Cl. H04L 43/08; H04L 67/1097

(52) U.S. Cl. CPC H04L 43/08; H04L 67/1097

(57) ABSTRACT

Methods, apparatuses, and systems provide a generic Remote Direct Memory Access (RDMA) metrics engine in data center (DC) leaf switches which provides full visibility of RDMA level metrics emanating from the connected endpoints by performing bi-directional matching using flow table(s). A method is provided that involves a network device obtaining, from an endpoint device, a remote direct memory access (RDMA) data flow and performing a bi-directional matching of a RDMA request with a corresponding RDMA response based on flow match criteria. The method further involves generating RDMA level metrics for the RDMA data flow based on the bi-directional matching and providing the RDMA level metrics for determining a performance of the RDMA data flow.

### TECHNICAL FIELD

The present disclosure generally relates to networking and network equipment.

### BACKGROUND

Remote direct memory access (RDMA) is a data transfer technology that allows network interface cards (NICs) to directly transfer data between two application memories without a kernel or central processing unit (CPU) involvement. The NIC implements the entire network protocol stack, which improves throughput and lowers latency. RDMA-based data transfer technology is commonly adopted in data centers for backend and frontend data center networks.

Due to throughput and latency considerations in data center networks, using RDMA over converged Ethernet version 2 (RoCEv2) in a lossless Ethernet fabric is quickly becoming the transport of choice. RoCEv2 encapsulates RDMA messages in User Datagram Protocol (UDP)/Internet Protocol (IP) packets. However, monitoring performance and troubleshooting RDMA-based data transfers in the RoCEv2 fabric present unique challenges. For example, gaining visibility into encapsulated RDMA messages is difficult.

### BRIEF DESCRIPTION OF THE DRAWINGS

FIG. 1 is a block diagram depicting an environment in which RDMA engines for generating RDMA level metrics are deployed in leaf switches, according to an example embodiment.

FIG. 2 is a diagram illustrating components of an edge port of a leaf switch of FIG. 1, according to an example embodiment.

FIG. 3 is a diagram illustrating metric tables that are stored in a RDMA storage of FIG. 2 for performing bidirectional matching and generating RDMA level metrics, according to an example embodiment.

FIGS. 4A and 4B are views illustrating RDMA level metrics stored in a flow metrics list of one of the metric tables of FIG. 3 based on a determined context of the RDMA data flow, according to one or more example embodiments.

FIGS. 5A, 5B, and 5C are sequence diagrams illustrating inter-GPU transactions between two endpoint devices for which RDMA level metrics are generated, according to one or more example embodiments.

FIGS. 6A and 6B are sequence diagrams illustrating input and output (I/O) storage transactions between two endpoint devices for which RDMA level metrics are generated, according to one or more example embodiments.

FIG. 7 is a diagram illustrating an environment in which an RDMA engine is deployed for dual homed endpoint devices, according to another example embodiment.

FIG. 8 is a flowchart illustrating a method of providing RDMA level metrics for determining a performance of RDMA data flow, which are generated based on bidirectional matching of RDMA requests with corresponding responses, according to an example embodiment.

FIG. 9 is a hardware block diagram of a computing device that may perform functions associated with any combination of operations in connection with the techniques depicted in FIGS. 1-3, 4A, 4B, 5A, 5B, 5C, 6A, 6B, 7, and 8 according to various example embodiments.

FIGS. 10A and 10B are hardware block diagrams of device(s) that may perform functions associated with any combination of operations in connection with the techniques depicted and described in FIGS. 1-3, 4A, 4B, 5A, 5B, 5C, 6A, 6B, 7, and 8, according to various example embodiments.

### DESCRIPTION OF EXAMPLE EMBODIMENTS

### Overview

Methods, apparatuses/devices, and systems include a generic RDMA metrics engine that provides full visibility of RDMA level metrics emanating from the connected endpoints by performing bi-directional matching using flow table(s).

In one form, a method is provided that involves a network device obtaining, from an endpoint device, a remote direct memory access (RDMA) data flow and performing a bi-directional matching of a RDMA request with a corresponding RDMA response based on flow match criteria. The method further involves generating RDMA level metrics for the RDMA data flow based on the bi-directional matching and providing the RDMA level metrics for determining a performance of the RDMA data flow.

### Example Embodiments

As noted above, in RDMA data transfer technology, data is directly transferred between two application memories without a kernel or CPU involvement. In RDMA, there are two programming interfaces. A first programming interface involves verbs. A second programming interface involves control and data in which a connection is setup. Specifically, an application first calls several control verbs to allocate a queue pair (QP) and a completion queue (CQ), to set up a reliable connection (RC) or an Extended RC (XRC) transmission between endpoints. The application then registers a memory region (MR) that enables the RDMA NIC (RNIC) to directly read/write to/from this MR. Applications can use data verbs like SEND, WRITE, READ, and ATOMIC for data transfers. As noted above, RDMA in a RoCEv2 data center fabric may be used in a variety of ways including backend and frontend data center networks.

Specifically, backend data center networks involve graphics processing unit (GPU) cluster communications. Deep learning frameworks run on a GPU cluster and use GPU vendor specific communication frameworks called extended collective communications library (xCCL) for inter-GPU communications. Data transfers may involve point to point and collective communications. For example, xCCL translates collectives into logical topology implementations such as a ring or a tree using RDMA send and write operations. The GPU-to-GPU transactions may be over multiple QPs between the ranks of a job.

Frontend data center networks involve storage communications. For high performance storage, RDMA is used for moving data from a storage server memory to a client memory. The compute server (client) first posts an MR request and then posts an RDMA send request with an input/output (I/O) command and memory key to the storage server. The data transfer is then initiated by the storage server using RDMA read or write. After the data transfer, the storage server sends a response to the compute server using RDMA send with invalidate.

Some examples of storage solutions that use RDMA include Internet Protocol (IP) storage area network (SAN), artificial intelligence (AI) storage systems, and scale out storage systems. IP SAN may be a centralized storage array or a disaggregated storage array offering nonvolatile memory express (NVMe) block storage to applications. NVMe over fabrics when using RDMA follows the NVMe/RoCEv2 protocol. The AI storage systems are file or object storage servers used for data loading and checkpointing for AI training or inferencing workloads. While a variety of portable operating system interface (POSIX) compliant and vendor specific file systems are used, network file system (NFS) over RDMA is standardized by Internet Engineering Task Force (IETF), as specified in IETF Request for Comments (RFC) § 8166 titled “Remote Direct Memory Access Transport for Remote Procedure Call”. Early versions of some object storage using RDMA are also available such as RFC § 8166 S3 with RDMA. RDMA provides performance boost to speed up training times with respect to storage access. The scale out storage systems, such as cloud storage, use storage operations among the nodes of the cluster. These storage systems use RDMA over RoCEv2 for storage operations among the nodes of the cluster. As such, RDMA is commonly used for storage solutions whether file or block.

A network administrator operating RoCEv2 networks today uses a combination of NIC and switch telemetry data or metrics for troubleshooting. Telemetry data, which may be referred to as measurement data, interchangeably and sometimes also called “metrics” or “collection data”, are values obtained from monitoring i.e., monitoring by network devices performance of a network and/or endpoint devices. The telemetry data includes various information such as identifiers, timestamps, interfaces visited, queue depth, etc.

As an example, counters of NICs are related to packet drops, link flaps, and packet timeouts. These count values are stored in counters at the NIC. The counters of switches are related to priority flow control (PFC) watchdogs, buffer utilization, congestion drops, and network round-trip time (RTT). These count values are stored in counters at the switch. While these counters help track packet loss and the resulting degradation, they are not useful for deeper insights into a RDMA level performance. For example, there could be errors at the RDMA level with no packet loss. This may occur when there are mismatched sends, without a receive, or when RDMA operations have incorrect memory key. In other words, monitoring RDMA traffic at the host level and the network level is not sufficient to detect at least some of the problems encountered at the RDMA level. The related art techniques lack visibility into the underlying RDMA messages and does not provide effective troubleshooting of failed or slow RDMA workloads in some instances. In short, related art techniques do not resolve some of the network problems encountered at the RDMA level.

Many data center switches support FlowTable/Netflow® technologies that capture flow of telemetry data for a standard 5-tuple. In a RoCEv2 fabric, this collapses all the RDMA flows across different QPs between a source IP (SIP) and destination IP (DIP) into a single flow which is of limited use. Some switch vendors may offer a slightly better form of telemetry data for RoCEv2 fabric giving visibility into QP level metrics by examining control verbs passing through the switch and identifying RoCEv2 flows such as a Netflow-like feature for RoCEv2 flows without visibility into RDMA messages (data verbs).

Recently, some effort has been made to obtain RDMA level telemetry data or metrics from the host network stack and/or from the RDMA NICs. For example, efforts have been made to obtain fine-grained visibility into each storage operation from a host stack and for data processing units (DPUs) providing a software for network applications in packages that can be programmed to collect RDMA storage I/O related metrics per remote block device either natively or using Storage Performance Development Kit (SPDK). However, computing metrics in the NIC data path comes at the cost of performance and accuracy.

That is, building a solution using RDMA telemetry data or RDMA level metrics from the host operating system (OS)/NICs may have some drawbacks. One drawback is that NIC RDMA telemetry data is focused on a specific use-case such as a storage access only. Another drawback is that not every NIC has this telemetry collection capability, which may result in observability “dark spots” in a large network fabric. Yet another drawback may be that, in a large network fabric, consuming telemetry data from potentially hundreds or thousands of NICs/endpoint devices has scale challenges in a telemetry receiver. Moreover, integrating with different NIC vendors telemetry export mechanisms is challenging and error prone. Also, having a slow or “stuck” NIC is common. In these instances, metrics from these endpoint devices may be unavailable or unreliable. It should be noted that if user preferences are to be considered, network administrators prefer Netflow information from switches, which acts as a primary consumption source for flow analysis solutions and typically do not use telemetry data from NIC/host network stack.

In short, troubleshooting RDMA performance issues in an RoCEv2 fabric is limited despite many existing RDMA metrics options since none of these options provide visibility into all types of RDMA messages. Troubleshooting and performance monitoring may be improved by detecting problems in Layer 4 RoCEv2 transactions (RDMA transactions) that are specific to RDMA. There is no mechanism that provides a generic RDMA metrics collection and export solution from a central entity like the fabric switch.

Techniques presented herein provide a generic RDMA metrics engine, deployed in data center leaf switches. The RDMA metrics engine provides full visibility of RDMA transactions emanating from the connected endpoint devices. The RDMA metrics engine may be executed on edge ports (host facing) of the leaf switches in the RoCEv2 fabric. An Application Specific Integrated Circuit (ASIC) in a switch uses an access control list (ACL) feature to examine RDMA data flows of interest and packets such as a first packet, a last packet, acknowledgement (ack) packets, and negative acknowledgement (nack) packets. Computing RDMA level metrics is performed using bi-directional matching of RDMA requests with corresponding RDMA response frames in a data path for every RDMA data flow.

In one or more example embodiment, RDMA level metrics are computed based on the bi-directional matching. Specifically, RDMA telemetry or metrics computations may be performed using two hash tables. A first hash table is a flow table, in which an entry is generated for a first data packet of an RoCEv2 flow using 5-tuple, as a key. A second hash table is an opcode table in which every entry is a child of an entry in the flow table. This second hash table is an ephemeral table that maintains state for transactions/messages that are in transit. As the RDMA operation starts, an entry is created in the opcode table and as it completes, the entry is flushed and RDMA level metrics are computed and aggregated in the corresponding parent flow table entry.

In one or more example embodiments, these hash tables that form the basis for the RDMA telemetry engine may be natively implemented inside a programmable ASIC or in an external entity like a data processing unit (DPU) connected to the ASIC.

While one or more example embodiments described below primarily focus on RoCEv2 fabric, the techniques are not limited thereto. The techniques may be extended to other network fabrics that transmit RDMA data flows such as Ultra Ethernet (UET) fabric.

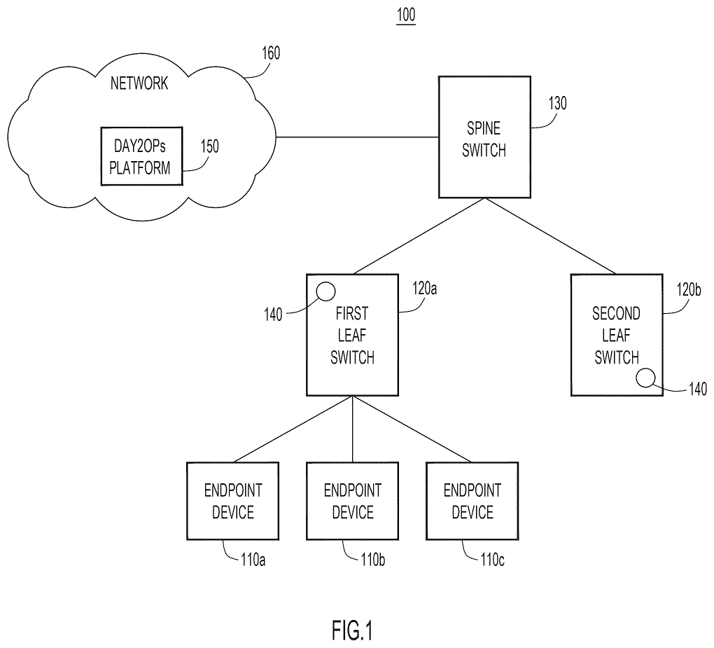

Turning now to FIG. 1, FIG. 1 is a block diagram illustrating an environment 100 in which RDMA engines for generating RDMA level metrics are deployed in leaf switches, according to an example embodiment. The environment 100 may be a data center (DC) machine learning/artificial intelligence (ML/AI) computing environment that includes spine-leaf network fabric that connects a plurality of endpoint devices 110a-110c to leaf switches such as a first leaf switch 120a, a second leaf switch 120b, which are connected to a spine switch 130. In the environment 100, one or more leaf switches may include an RDMA engine 140 that computes RDMA level metrics and provides these metrics to an ongoing maintenance, monitoring and optimization platform such as a Day 2 operations (Day2Ops) platform 150, which may be deployed in a cloud or network(s) 160.

The notations 1, 2, 3, . . . n; a, b, c, . . . n; “a-n”, “a-b”, “a-c”, “a-d”, “a-k”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

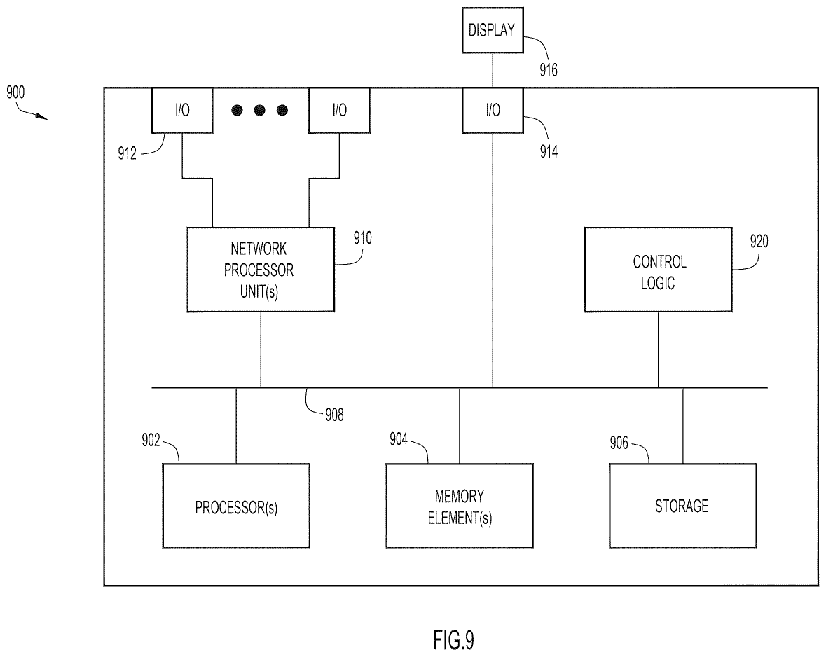

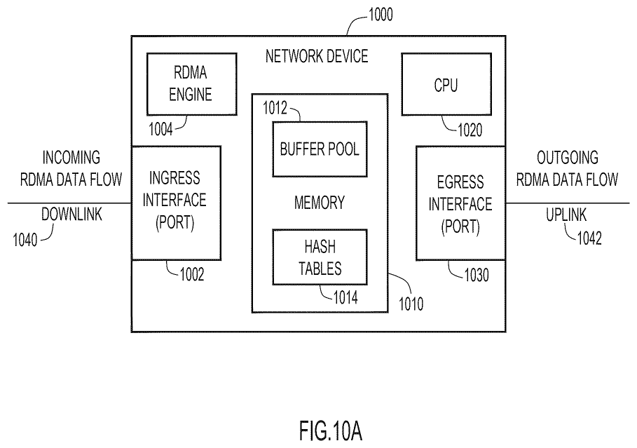

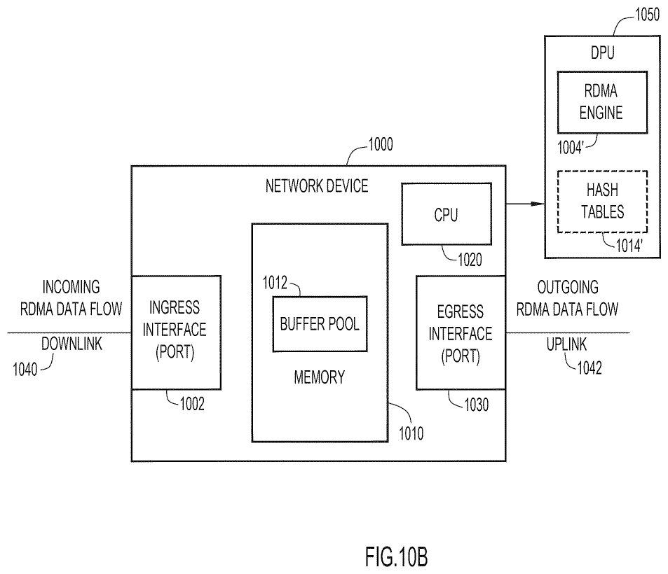

In various example embodiments, the entities of the environment 100 (the plurality of endpoint devices 110a-110c, the leaf switches 120a-120b, the spine switch 130, and the Day2Ops platform 150) may each include a network interface, at least one processor, and a memory. Each entity may be any programmable electronic device capable of executing computer readable program instructions. The network interface may include one or more network interface cards (having one or more ports) that enable components of the entity to send and receive data over the network(s) 160. Each entity may include internal and external hardware components such as those depicted and described in further detail in FIG. 9 or in FIGS. 10A and/or 10B. In one example, at least some of these entities may be embodied as virtual devices with functionality distributed over a number of hardware devices such as virtual switches, routers, etc.

In the environment 100, the plurality of endpoint devices 110a-110c include a first endpoint device 110a, a second endpoint device 110b, and a third endpoint device 110c. Each of the plurality of endpoint devices 110a-110c may be a computing device, a client device, or a host device that generates data based on input for a user e.g., an operator, an example of which is described in FIG. 9. In one example embodiment, the endpoint device may be a server executing one or more enterprise services e.g., storing data, performing artificial intelligence (AI) operations, etc. In another example embodiments, the endpoint device may include a user interface using which an operator interacts with the Day2Ops platform 150. The plurality of endpoint devices 110a-110c such as servers that support AI-based applications and AI training and storage devices that store enterprise data may be hosted in a data center. In a data center fabric, data is transported to and from the plurality of endpoint devices 110a-110c using network devices or network nodes.

The network devices may be in a form of spine-leaf architecture, as shown in the environment 100. Specifically, the first leaf switch 120a, the second leaf switch 120b, and the spine switch 130 are transport nodes that transport data flows between the plurality of endpoint devices 110a-110c and send telemetry information to a data platform. This is just one example. The network devices may include, but are not limited to switches, virtual routers, leaf nodes, spine nodes, etc. The network devices may include a central processing unit (CPU), a memory, a packet processing logic, an ingress interface, an egress interface, one or more buffers for storing various packets of various traffic flows, and one or more interface queues such as those depicted and described in FIGS. 10A and 10B, by way of examples.

In the environment 100, the data center fabric is a spine-leaf architecture in which a first layer includes access or leaf switches 120a-120b that aggregate RDMA data traffic flows from the connected endpoint devices. The leaf switches 120a-120b are connected to a second switching layer i.e., the spine switch 130 or a network core. The spine switch 130 may interconnect the leaf switches 120a-120b in a full-mesh topology, for example.

The leaf switches 120a-120b may each include the RDMA engine 140. The RDMA engine 140 generates RDMA level metrics such as number of transactions, data transfer sizes, latency values, and error metrics. The RDMA level metrics are computed based on bi-directional matching of RDMA request and response frames in data path for every RDMA data flow. The RDMA level metrics may provide visibility at an RDMA message level. The RDMA engine 140 is deployed on host facing edge ports of leaf switches 120a-120b in an RoCEv2 fabric.

The Day2Ops platform 150 is an example of a network analysis entity or a software application that stores and analyzes telemetry data such as the RDMA level metrics to assess network performance, and more specifically, RDMA level performance, and/or performs troubleshooting based on a detected network problem at RDMA level. The Day2Ops platform 150 provides for monitoring, ongoing maintenance, and optimization of deployed application(s). The Day2Ops platform 150 stores historic telemetry data in a data lake for various visualizations, trend analysis, and deeper insights using various machine learning ML/AI algorithms. The Day2Ops platform 150 may analyze the telemetry data and configure one or more of the network devices based on this analysis. such as one of the switches in the environment 100.

In one example embodiment, the Day2Ops platform 150 may perform a troubleshooting operation of a networking environment based on RDMA specific error metrics such as a count value of negative acknowledge packets in the RDMA data flow. The Day2Ops platform 150 may determine a network problem or a potential network issue based on the RDMA specific error metrics such as a reason code in each negative acknowledgement packet of the RDMA data flow. The Day2Ops platform 150 may then connect to a network controller and/or various network devices and change their configurations to resolve the network problem. Configuration actions to resolve the network problem may involve reconfiguring a network port of a network device, rebooting a GPU that is exhibiting a problem, proactively reconfiguring network links based on detected congestions. The Day2Ops platform 150 may be deployed on one or more computing devices such as servers or in a cloud.

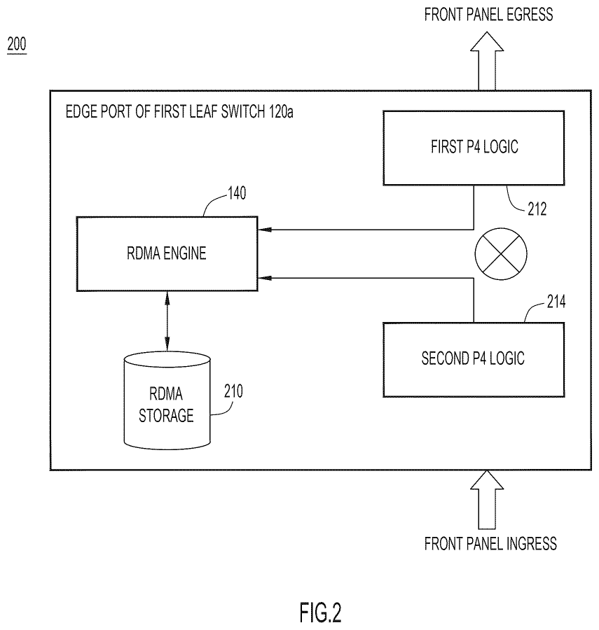

With continued reference to FIG. 1, FIG. 2 is a diagram illustrating components 200 of an edge port in the first leaf switch 120a of FIG. 1, according to an example embodiment. The components 200 include the RDMA engine 140 and an RDMA storage 210 that stores metrics tables. The components 200 further include a first Programming Protocol-Independent Packet Processor (P4) logic 212 that parses packets at an ingress of the edge port and a second P4 logic 214 which parses the packets at the egress of the edge port.

In one or more example embodiments, the edge port is an ingress interface port that obtains RDMA data flows from the endpoint devices 110a-110c (front panel ingress and egress). That is, the edge port of the first least switch 120a faces the plurality of endpoint devices 110a-110c in the RoCEv2 fabric.

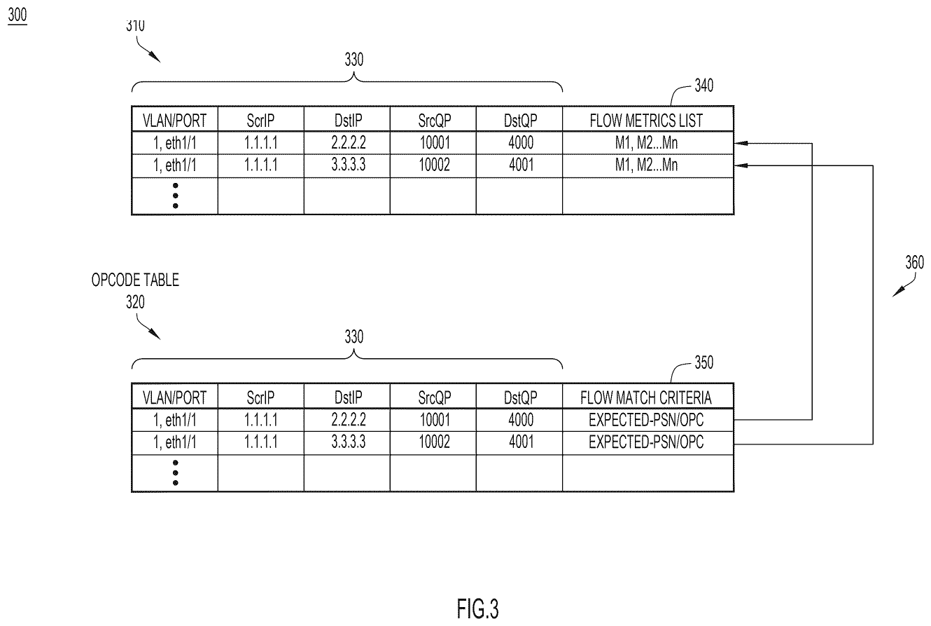

The RDMA engine 140 includes a switching ASIC that may apply access control list (ACL) feature to examine RDMA data flows and particular packets. The RDMA engine 140 uses the ACL feature to examine a destination port and a source port, i.e., RoCEv2 of the RDMA data flows. The RDMA engine 140 extracts packets of interest in each RDMA data flow. Packets of interest may include first and last packets of the RDMA data flow, acknowledgement (ACK) and negative acknowledgement (NACK) packets of the RDMA data flow, and/or RDMA read requests. The RDMA engine 140 performs bi-directional matching of a RDMA request with a corresponding RDMA response based on flow match criteria and generates RDMA level metrics for the RDMA data flow based on the bi-directional matching using metrics tables in the RDMA storage 210, an example of which is described with reference to FIG. 3. In other words, every packet of interest in the RDMA data flow is examined resulting in line rate RDMA telemetry data. The RDMA engine 140 computes RDMA level metrics or telemetry data using hash tables stored in RDMA storage 210.

As noted above, the RDMA engine 140 may be implemented natively in an ASIC using P4 logic or by sending packets of interest from the data path to an attached programmable device like a data processing unit (DPU). That is, the RDMA engine 140 may be implemented inside an ASIC, an example of which is shown in FIG. 10A, or an external DPU with the ASIC forwarding packets of interest to the DPU, an example of which is shown in FIG. 10B.

The RDMA storage 210 may be a metrics tables database. The RDMA storage 210 stores the RDMA level metrics and one or more hash tables for performing bi-directional matching.

The first P4 logic 212 and the second P4 logic 214 include an Opcode parser that is configured to examine or parse RoCEv2/InfiniBand (IB) headers. Specifically, the RoCEv2 encapsulates IB transport header and a data payload with IP/User Datagram Protocol (UDP) headers. The ROCEv2 flow includes a source IP, a destination IP, and QPs such as destination QP in an IB BTH header (Layer 4 header), which is per direction. In the case of an Ultra Ethernet Consortium (UEC) deployment, an Ultra Ethernet Transport (UET) frame is encapsulated in UDP and a packet identifier (PID) on a fabric end point (FEP) is equivalent to a QP. The first P4 logic 212 provides packets from the egress direction for matching with packets from the ingress direction provided by the second P4 logic 214.

With continued reference to FIGS. 1 and 2, FIG. 3 is a diagram illustrating metrics tables 300 that are stored in the RDMA storage 210 of FIG. 2 for performing bidirectional matching and generating RDMA level metrics, according to an example embodiment. The metrics tables 300 includes a flow table 310 and an opcode table 320.

The metrics tables 300 may be hash tables. Each of the metrics tables 300 includes a match key 330. In one example embodiment, the match key 330 is a 5-tuple key. As an example, the match key 330 includes a virtual local access network (VLAN), VLAN port, source IP address (Src IP), destination IP address (Dst IP), destination queue pair (DstQP) such as Source QP (SrcQP) and destination QP (DstQP). For example, the match key 330 may include: VLAN/Port “1, eth1/1”, SrcIP “1.1.1.1”, DstIP “2.2.2.2”, SrcQP “10001”, DstQP “4000”. The match key 330 includes information for performing bi-directional matching of requests and responses of the RDMA data flow. The match key 330 includes at least one identifier that may be extracted from fields in a header of RDMA packets of interest.

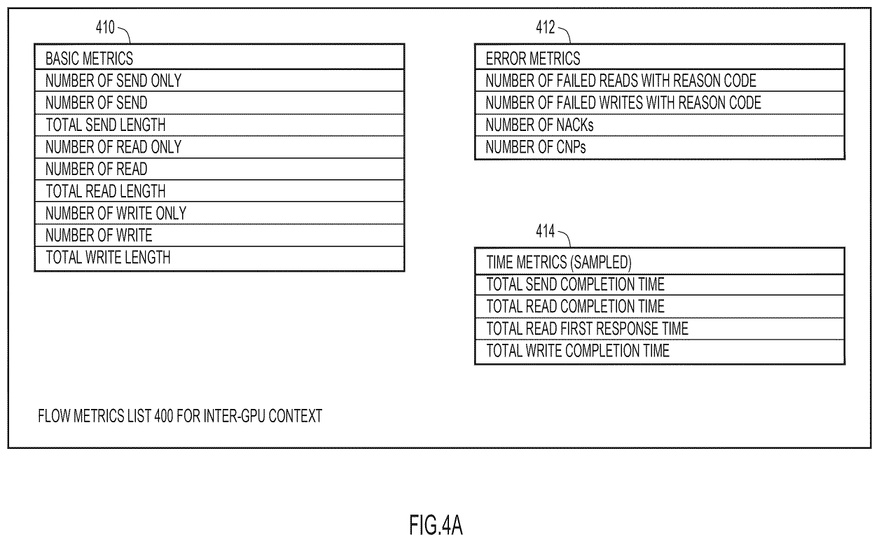

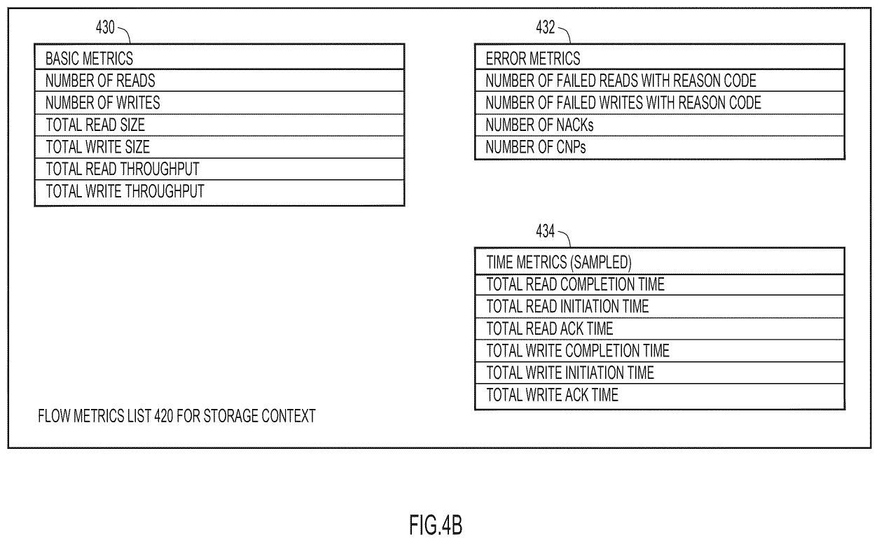

The flow table 310 includes an entry for every active RoCEv2 flow. That is, a row entry is created in the flow table 310 when the first data packet of the RDMA data flow for the tuple (the match key 330) is seen on an edge port of a leaf switch. In this example, the flow table 310 includes two entries for two different RDMA data flows. First RDMA data flow has a 5-tuple of “1, eth1/1”, “1.1.1.1”, “2.2.2.2”, “10001”, “4000” and a second RDMA data flow has a 5-tuple of “1, eth1/1”, “1.1.1.1”, “3.3.3.3”, “10002”, “4001.” The flow table 310 further includes a flow metrics list 340. The flow metrics list 340 includes generated RDMA level metrics for the RDMA data flow e.g., metrics M1, M2 . . . Mn. The RDMA level metrics may include generated RDMA message level specific values. For example, the RDMA level metrics may include latency related metrics, time related metrics, and error metrics, examples of which are described with reference to FIGS. 4A and 4B. The RDMA level metrics are generated based on bi-directional matching of the RDMA request with a corresponding RDMA response, which is performed based on the opcode table 320.

The opcode table 320 has an entry for every outstanding RoCEv2 opcode. That is, the opcode table 320 is a per-flow per-outstanding opcode with the match key 330 and a flow matching criteria 350. Every entry in the opcode table 320 is a child of an entry in the flow table 310. The flow matching criteria 350 may be a variable length field that matches an Opcode, packet sequence number (PSN), packet key (PKEY), command identifier (CID), etc., depending on a profile of the RDMA data flow or based on a type of the RDMA data flow. That is, identifiers for matching requests with responses at the RDMA level may vary depending on a type of RDMA data flow. The flow matching criteria 350 may be the expected PSN/OPC.

The opcode table 320 is an ephemeral table that maintains state for transactions/messages that are in transit. As the RDMA operation starts, an entry is created in the opcode table 320. When the RDMA operation completes, the entry is flushed from the opcode table 320, and RDMA level metrics are aggregated in the corresponding parent flow table entry in the flow metrics list 340 of the flow table 310, as shown at 360.

In one example embodiment, the RDMA engine 140 supports the Ultra Ethernet Fabric where RDMA is still the basic bulk data transfer mechanism. In this instance, the RoCEv2 BTH header parsing logic is changed to inspect Ultra Ethernet Transport (UET) headers while the rest of the logic remains the same. In other words, the flow matching criteria 350 is obtained from the UET headers for the bi-directional matching of the RDMA request with a corresponding RDMA response (e.g., PID).

With continued reference to FIGS. 1-3, FIGS. 4A and 4B illustrate the RDMA level metrics stored in the flow metrics list 340 of FIG. 3 based on a determined context of the RDMA data flow, according to one or more example embodiments. Specifically, FIG. 4A illustrates a flow metrics list 400 generated for the RDMA data flow determined to have the context of an inter graphics processing unit (GPU) transaction and FIG. 4B illustrates a flow metrics list 420 for the RDMA data flow determined to have the context of a storage transaction i.e., storage context, according to one or more example embodiments.

In one or more example embodiments, the RDMA engine 140 determines the context of each RDMA data flow or identifies the use profile based on metadata of the RDMA data flow, and then computes metrics based on the identified use profile. In other words, the RDMA engine 140 associated with the flow table 310 is configured to glean different types of RDMA profiles.

In a typical application using RDMA, application level data transactions are converted into RDMA messages, which are further converted to Ethernet packets. Based on the determined profile of the RDMA data flow, the RDMA engine 140 may extract RDMA telemetry data either at a transaction level, a message level and/or a packet level, depending on a use case scenario. In other words, the type of RDMA level metrics that are generated and stored in the flow metrics list 340 depends on the context of the RDMA data flow. The context may be inter-graphics processing unit (Inter-GPU) transactions or storage (file or block) transactions.

When the RDMA data flow is for an Inter-GPU transaction, such as a ncclAllReduce API transaction from a deep learning application framework, the Inter-GPU transaction is translated into multiple RDMA sends and write messages, which are then packetized into several Maximum Transmit Unit (MTU) size Ethernet/IP packets.

Based on the RDMA engine 140 determining the context to be Inte-GPU transaction, the RDMA engine 140 computes RDMA level metrics at a RDMA message level. Since the transaction level metrics of Inter-GPU transactions e.g., number of ncclBroadcast calls, latency of ncclAllReduce metrics, may use vendor specific application programming interface (API) internal knowledge, the RDMA engine 140 is configured to compute RDMA telemetry data at the message level.

As shown in FIG. 4A, the flow metrics list 400 for Inter-GPU context includes RDMA level metrics per-port and per-flow. For Inter-GPU transactions, the RDMA level metrics include basic metrics 410, error metrics 412, and time metrics 414, computed at the RDMA message level.

The basic metrics 410 include one or more of: (1) number of send only messages, (2) number of send messages, (3) total length of send messages, (4) number of read only messages, (5) number of read messages, (6) number of total read length, (7) number of write only messages, (8) number of write messages, and (9) total write length.

The error metrics 412 include one or more of: (1) number of failed read messages with a reason code, (2) number of failed write messages with the reason code, (3) number of negative acknowledgment messages (NACKs), and (4) number of congestion notification packets (CNPs).

The time metrics 414 include one or more of: (1) total send completion time, (2) total read completion time, (3) total read first response time, and (4) total write completion time.

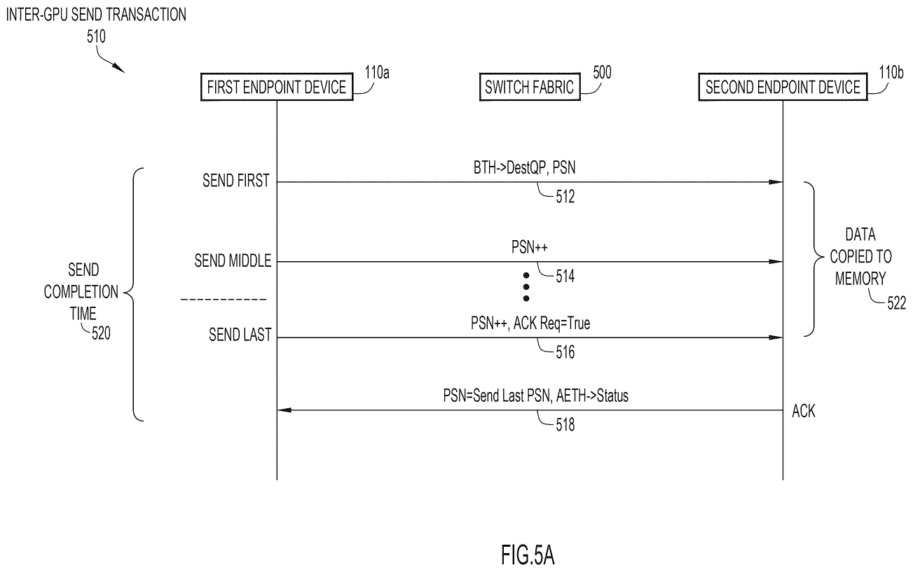

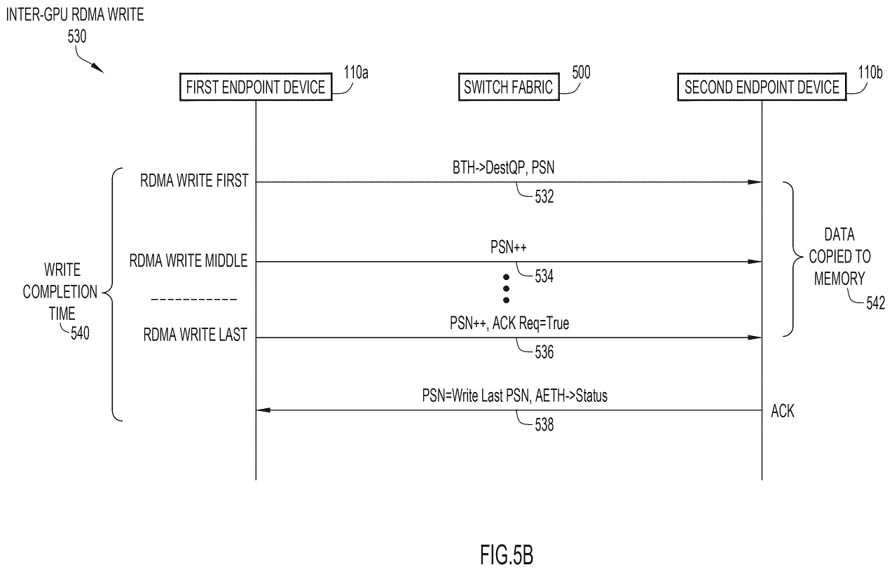

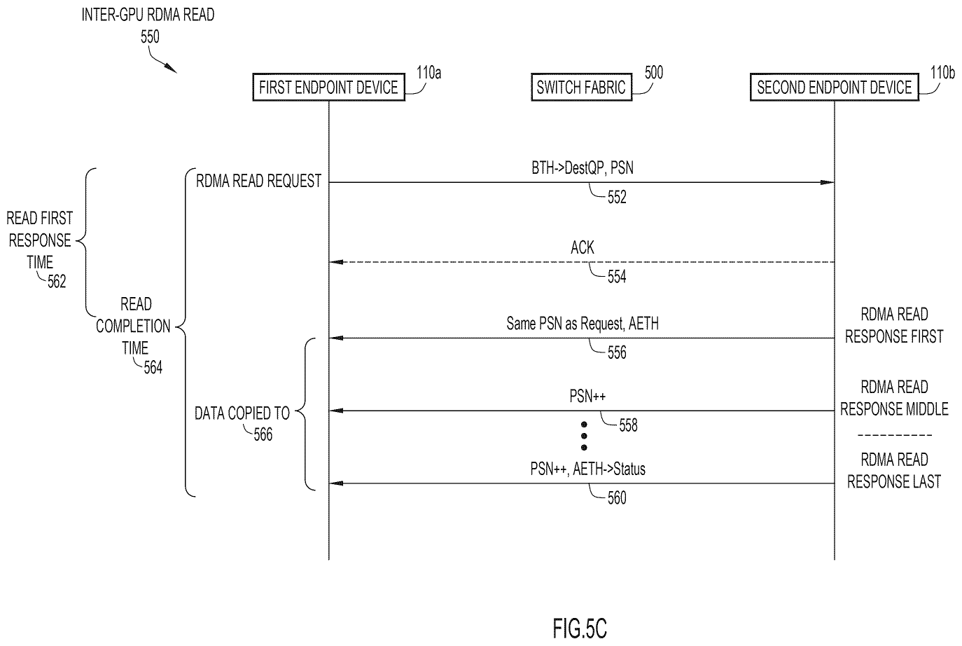

The RDMA engine 140 computes these RDMA level metrics at the message level for various Inter-GPU transactions based on performing bi-directional matching described in further detail in FIGS. 5A, 5B, and 5C.

When the RDMA data flow is for a storage transaction such as a non-volatile memory express (NVMe) read input/output (I/O) transaction from an application block storage API, the storage transaction is translated into multiple messages such as RDMA send, RDMA write, and RDMA send invalidate. Some of the larger messages, such as the RDMA write, may further be packetized as an RDMA write first Ethernet/IP packet, multiple RDMA write middle Ethernet/IP packets, and an RDMA write last Ethernet/IP packet. In the storage context, for standardized storage protocols e.g., NVMe/RoCEv2, NFSoRDMA, with input and output (I/O) boundaries clearly defined by standards, the RDMA engine 140 is configured to compute I/O transaction metrics. In other words, the RDMA telemetry data is generated at the I/O transaction level.

As shown in FIG. 4B, the flow metrics list 420 for RDMA storage transactions includes basic metrics 430, error metrics 432, and time metrics 434. These metrics are at the RDMA transaction level. The flow metrics list 420 is for RDMA storage transactions such as NVMe/RoCEv2 type and are per port and per flow.

At the input/output transaction level, the basic metrics 430 include one or more of: (1) number of reads, (2) number of writes, (3) total read size, (4) total write size, (5) total read throughput, and (6) total write throughput. The error metrics 432 include one or more of: (1) number of failed reads with a reason code, (2) number of failed writes with the reason code, (3) number of negative acknowledgments (NACKs), and (4) number of congestion notification packets (CNPs). The time metrics 434 include one or more of: (1) total read completion time, (2) total read initiation time, (3) total read acknowledgement time, (4) total write completion time, (5) total write initiation time, and (6) total write acknowledgement time.

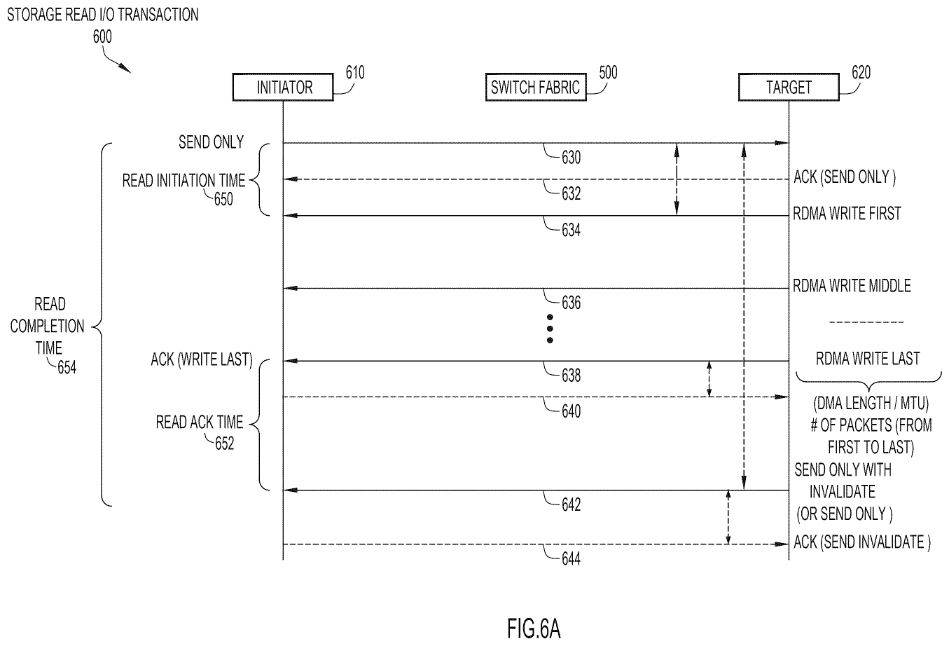

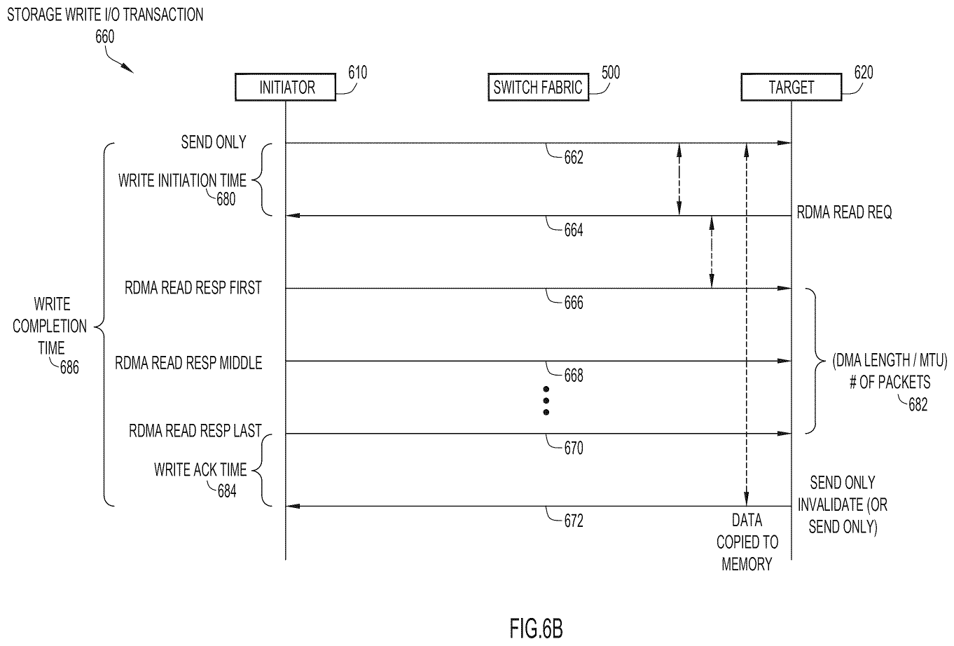

The RDMA engine 140 computes these RDMA level metrics at the input and output transaction level for various RDMA storage transactions based on performing bi-directional matching of transaction requests with responses described in further detail in FIGS. 6A and 6B.

For both RDMA transaction and message levels metrics, the RDMA engine 140 identifies fields in packet headers that may be used to tie together the requests with responses of a given transaction and/or message.

As explained above, in addition to the basic RDMA metrics and latency or time RDMA metrics, several RDMA error metrics are also captured that may be helpful for troubleshooting (resolving a network problem). For example, the NACK that shows a failure at the RDMA receiver is indicative of a packet loss. The NACK reason code carried in the AETH header provides hints for troubleshooting by the Day2Ops platform 150 of FIG. 1. The CNP packets reflect explicit congestion notification (ECN) marked packets to the senders by the receivers. A receiver may send one CNP packet for every ‘n’ of ECN packets. The DestQP is set to the QP for which the CNP is generated and helps identify the congested QP at the sender and as such, may help resolve a network problem at the sender.

These RDMA level metrics are provided by way of an example only and not by way of a limitation. Other RDMA level telemetry metrics are within the scope of this disclosure. Additionally, in one example embodiment only some these of RDMA level metrics may be computed.

With continued reference to FIGS. 1-3 and 4A, FIGS. 5A, 5B, and 5C are sequence diagrams illustrating inter-GPU transactions between two endpoint devices for which RDMA level metrics are generated, according to one or more example embodiments. The two endpoint devices may be the first endpoint device 110a and the second endpoint device 110b of FIG. 1, which communicate with one another via a switch fabric 500 that includes, among other network devices, the first leaf switch 120a of FIG. 1.

The RDMA engine 140 at the first leaf switch 120a may perform the bi-directional matching of RDMA request with the corresponding RDMA response by identifying fields in packet headers that link the two together. Type of identifiers that link the two together depends on the context of the RDMA data flow.

Based on determining the profile to be an inter GPU transaction, the RDMA engine 140 may extract a packet sequence number (PSN) field as the identifier for the flow matching criteria 350 of FIG. 3 that links RDMA requests with corresponding RDMA responses.

In general, RoCEv2 packet formats include at least an ethernet header (Layer 2), an Ethernet type, an IP header, a UDP header, an IB base transport header (BTH) (Layer 4), and an IB payload. The RoCEv2 encapsulates the IB transport header and a payload with IP/UDP headers. The BTH header includes an opcode that may define the type of packet (send, RDMA write, RDMA read) and a PSN. The RDMA engine 140 may perform bi-directional matching of RDMA requests and responses based on RoCEv2 UDP Port, BTH opcode and the PSN.

Specifically, FIG. 5A is a sequence diagram illustrating an inter-GPU send transaction 510 from the first endpoint device 110a to the second endpoint device 110b via the switch fabric 500 for which RDMA level metrics are computed, according to an example embodiment.

The inter-GPU send transaction 510 starts at 512, with the first endpoint device 110a sending a “send first” packet that includes a destination QP (DestQP) and a PSN in the BTH header. The RDMA engine 140 inspects the opcode of the RDMA “send first” packet. If the opcode is “RC send only” or “RC send first”, the RDMA engine 140 generates an entry in the opcode table 320 of FIG. 3 with flow information including QP (the match key 330). Since “send first” packet and “send only” packet have no length in the payload, the payload length is set equal to “UDPHdr. Length-UDPHdr- BTH Hdr-CRC” length.

For the “send first” packet, the PSN is saved or added to the opcode table 320 of FIG. 3 as the flow matching criteria 350, along with the payload length and a packet timestamp for matching or linking with the “send last” packet. On the other hand, if the packet is a “send only” packet, the RDMA engine 140 updates the flow table length and increments the number of “send only” in the flow metrics list 340 of the flow table 310 (and more particularly the basic metrics 410 of FIG. 4A).

Next, at 514, the first endpoint device 110a sends one or more “send middle” packets to the second endpoint device 110b via the switch fabric 500. With each “send middle” packet, the PSN is incremented. The RDMA engine 140 may ignore the “send middle” packets. That is, the “send middle” packet may not even be sent to the RDMA engine 140 by the parser if it is deemed as a packet not of interest.

At 516, the first endpoint device 110a sends a “send last” packet, in which the PSN is further incremented and an acknowledgement request is set to true (acknowledgement is to be provided). The RDMA engine 140 inspects the opcode of the “send last” packet to match with the “send first” packet. For example, if the opcode is “RC send last”, the RDMA engine 140 performs a lookup operation in the opcode table 320 for an outstanding “send first” packet (the saved PSN). Based on “send last” packet PSN minus the saved PSN, the number of “send middles” is computed. The RDMA engine 140 may multiply the number of “send middle” packets with the payload length plus the payload length of the “send last” packet, to generate a total send length value in the basic metrics 410 of FIG. 4A. Additionally, the RDMA engine 140 updates the flow metrics list 340 of the flow table 310 of FIG. 3 with the incremented number of sends and updates the PSN in the opcode table 320 of FIG. 3 to the “send last” packet.

At 518, the second endpoint device 110b sends an acknowledgement packet (ACK) to the first endpoint device 110a via the switch fabric 500. The PSN of the “send last” packet is used to match the acknowledgement packet, which has the same PSN. For example, if the opcode is “RC ACK”, the RDMA engine 140 inspects BTH. PSN to find a corresponding “send last” in the opcode table 320 of FIG. 3. The RDMA engine 140 updates or adds a send completion time value 520 (total send completion time of the time metrics 414 in FIG. 4A) by computing (ACK timestamp-“Send first” packet timestamp).

In case the syndrome field of this packet is set to “fail”, the RDMA engine 140 further updates the number of failed sends with a Syndrome bits failure code in the flow metrics list 340 of the flow table 310 (an example of the error metrics 412 in FIG. 4A). Additionally, the RDMA engine 140 computes the length of copying data to memory 522 to the second endpoint device 110b (total send length of the basic metrics 410 in FIG. 4A). In short, RDMA telemetry metrics are computed and added to the flow table 310 of FIG. 3. Based on the acknowledgement packet, the entry is then flushed or deleted from the opcode table 320 of FIG. 3 because the operation state of the RDMA Inter-GPU send transaction 510 is complete.

Turning now to FIG. 5B, FIG. 5B is a sequence diagram illustrating an inter-GPU RDMA write transaction 530 from the first endpoint device 110a to the second endpoint device 110b via the switch fabric 500 for which RDMA level metrics are computed, according to an example embodiment.

The inter-GPU RDMA write transaction 530 starts at 532, with the first endpoint device 110a sending a RDMA “write first” packet that includes the DestQP and the PSN in the BTH header. In the RDMA extended transport header (RETH), the “write first” packet may include a virtual address of the RDMA operation, a remote key that authorizes access for the RDMA operation, and a length of the DMA operation (DMA length).

For example, if opcode is RC Write Only or RC Write First, the RDMA engine 140 creates an entry in the opcode table 320 with flow information including QP. The RETH. DMALength has the total write length. Based on the opcode, if the RDMA engine 140 determines that this is a “write only” packet, the flow table 310 is updated by adding the write length metrics and incrementing the number of “write only” operations. If the RDMA engine 140 determines that this is a “write first” packet, the RDMA engine 140 computes the payload length. Using the payload length, the RDMA engine 140 determines the PSN of the “write last” packet and save it as the flow matching criteria 350 in the opcode table 320 (expected PSN value). Also, the RDMA engine 140 may add payload length, packet timestamp to the opcode table 320 as part of the flow matching criteria 350 (waiting for a matching “write last” packet).

Next, at 534, the first endpoint device 110a sends one or more RDMA “write middle” packets to the second endpoint device 110b via the switch fabric 500. With each “write middle” packet, the PSN is incremented with each packet. The RDMA engine 140 may ignore the “write middle” packets. That is, the “write middle” packet may not even be sent to the RDMA engine 140 by the parser if it is deemed as a packet not of interest.

The inter-GPU RDMA write transaction 530 further involves at 536, the first endpoint device 110a sending a RDMA “write last” packet, in which PSN is further incremented and an acknowledgement request is set to true. For example, if the opcode is RC Write Last, the RDMA engine 140 performs a lookup operation to find outstanding “write first” packets in the opcode table 320 using PSN of the packet. The flow table 310 is then updated with this length and the number of write messages are incremented in the flow metrics list 340. Moreover, the RDMA engine 140 updates the PSN stored in the opcode table 320 to the opcode of the “write last” packet. If AETH. Syndrome bits indicate failure, the failure code is updated or added to the flow table 310 and the number of failed write messages is incremented.

The inter-GPU RDMA write transaction 530 completes with the second endpoint device 110b sending an acknowledgement (ACK) message to the first endpoint device 110a via the switch fabric 500, at 538. The RDMA engine 140 in the switch fabric 500 performs bi-directional matching of the “write last” packet (request) and the acknowledgment message (response) based on the same PSN.

For example, if the opcode is equal to RC ACK, the RDMA engine 140 performs a lookup operation in the opcode table 320 using BTH. PSN to find the corresponding “write last” packet. The RDMA engine 140 then updates write completion time metrics 540 (a total write completion time value of the time metrics 414 in FIG. 4A), which is computed by subtracting the packet timestamp from the acknowledgement. If the syndrome field is equal to fail, the RDMA engine 140 further increments the number of negative acknowledgments (NACK) and the number of fail writes in the flow table 310. The RDMA engine 140 may further update the syndrome bits failure code in the flow table 310. The RDMA engine 140 computes the length of data copied to memory 542 of the second endpoint device 110b (a total write length value of the basic metrics 410 in FIG. 4A). Since the inter-GPU RDMA write transaction 530 is complete at 538, the entry is flushed from the opcode table 320.

Turning now to FIG. 5C, FIG. 5C is a sequence diagram an inter-GPU read transaction 550 from the first endpoint device 110a to the second endpoint device 110b via the switch fabric 500 for which RDMA level metrics are computed, according to an example embodiment.

The inter-GPU read transaction 550 starts at 552, with the first endpoint device 110a sending a RDMA “read first” request that includes the DestQP and the PSN in the BTH header. In the RDMA extended transport header (RETH), the “read first” request may include a virtual address of the RDMA operation, a remote key that authorizes access for the RDMA operation, and a length of the DMA operation (DMA length). The RDMA engine 140 matches packets based on RoCEv2 UDP Port, BTH. Opcode. For example, if the opcode is RC RDMA read request, the RDMA engine 140 generates an entry in opcode table 320 with flow info including QP. The RETH. DMA length has the total read length using which the RDMA engine 140 determines the payload length. Based on the payload length, the RDMA engine 140 determines the PSN of the expected read response last “Read_Resp Last” and saves the expected values as the flow matching criteria 350 in the opcode table 320. Additionally, the RDMA engine 140 also saves the payload length and the packet timestamp. The RDMA engine 140 may then wait for a matching read response first and read response last.

Next, at 554, the second endpoint device 110b sends an acknowledgement packet and at 556, sends an RDMA “read response first” packet. Since the RDMA “read response first” packet includes the same PSN as the RDMA “read first request” packet, the two packets are matched for generating RDMA message level metrics such as a read first response time value 562 (total read first response time of the time metrics 414 in FIG. 4A). For example, if the opcode is equal to RC read response only or RC read response first, the RDMA engine 140 performs a lookup operation to find an outstanding read request in the opcode table 320 using the PSN of packet. The RDMA engine 140 computes the read first response time value 562 by subtracting the packet timestamp from the response first timestamp. If the opcode indicates RC read response only, the flow table 310 is updated with the total read length and the number of read only messages are incremented (basic metrics 410 in FIG. 4A).

At 558, the second endpoint device 110b sends one or more RDMA “read response middle” packets to the first endpoint device 110a via the switch fabric 500. With each “read response middle” packet, the PSN is incremented. The RDMA engine 140 may ignore these “read response middle” packets. That is, the “read response middle” packet may not even be sent to the RDMA engine 140 by the parser if it is deemed as a packet not of interest.

The inter-GPU read transaction 550 completes with the second endpoint device 110b sending a RDMA “last read response” packet, at 560. In the “last read response” packet, the PSN corresponds to the PSN in the RDMA “read request last” packet from the first endpoint device 110a. That is, the RDMA engine 140 in the switch fabric 500 performs bi-directional matching of the request and response based on the same PSN. For example, if the opcode is set to RC read response last, the RDMA engine 140 performs a lookup operation for an outstanding read last PSN in the opcode table 320 using the PSN of packet. The RDMA engine 140 further generates a read completion time value 564 and increments the number of reads (basic metrics 410 in FIG. 4A). Additionally, if the AETH. syndrome bits indicate failure, the RDMA engine 140 updates the failure code in the flow table 310 and increments the number of failed reads. In addition to the read completion time value 564, the RDMA engine 140 computes a length of data copied to memory value 566 of the first endpoint device 110a (total read length of the basic metrics 410 of FIG. 4A).

In short, for inter-GPU type transactions, the RDMA engine 140 matches packets on the RoCEv2 UDP Port using the BTH. opcode (the PSN is used to link the requests with the responses). Once the inter-GPU transaction is complete, the entry is deleted from the opcode table 320 of FIG. 3.

In one or more example embodiments, the RDMA engine 140 inspects the opcode of the RDMA messages for AI inter-GPU type transactions to compute RDMA message level metrics. The RDMA engine 140 analyzes RDMA packets that include the opcode “Only”, “First,” “Last,” “Ack,” and “Nack”. RDMA packets that have “middle” opcode are not inspected or parsed. That is, packets with the “middle” opcode are not inspected or parsed due because these packets are not sent to the RDMA engine 140 from the data path.

The RDMA engine 140 determines useful information to resolve a network problem based on send, read, write, read response, and acknowledgement information present in an opcode field of BTH. NACK encoded in a syndrome field of the acknowledgement frame. For example, negative acknowledgements (NACKs) typically indicate packet loss that triggers an indicator of performance degradation. The RDMA engine 140 uses the PSN to match ingress/egress packets. As an example, the PSN in a first response/ACK matches the RDMA response with the request and last PSN to be cached per-flow is also stored for matching. Syndrome bits of the AETH header in the last RDMA packet indicates success or failure. The RDMA engine 140 computes and stores RDMA metrics on a per{Port/VLAN, SrcIP, DstIP, SrcQP, DstQP} for up to ‘N’ flows depending on the available internal memory of the switching device.

With continued reference to FIGS. 1-3 and 4B, FIGS. 6A and 6B are sequence diagrams illustrating NVMe input and output (I/O) storage transactions between two endpoint devices for which RDMA level metrics are generated, according to one or more example embodiments. The two endpoint devices may include an initiator 610 that initiates an input or output storage transaction and a target 620. The two endpoint devices communicate with each other over the switch fabric 500 which includes the first leaf switch 120a of FIG. 1.

Specifically, FIGS. 6A and 6B illustrate a storage read input and output transaction 600 and a storage write input and out transaction 660, respectively, for which RDMA transaction level metrics are computed, according to one or more example embodiments. Based on identifying the context of the RDMA data flow as a block storage transaction, command identifier (CID) may be used for matching logic (flow matching criteria 350 of FIG. 3). The RDMA engine 140 extracts a command identifier (CID) as an identifier for the bi-directional matching.

Turning now to FIG. 6A, FIG. 6A is a sequence diagram illustrating the storage read input and output transaction 600 from the initiator 610 to the target 620 via the switch fabric 500 for which RDMA level metrics are computed, according to an example embodiment. The storage read input/output transaction 600 may be a block storage NVMe/RoCE read I/O transaction.

The storage read input and output transaction 600 starts at 630, with the initiator 610 sending a “send only” packet to the target 620 via the switch fabric 500. The “send only” packet includes a payload opcode “read” and a payload CID. The BTH header includes the DestQP, PSN. The payload further includes a virtual address, a rkey, and a DMA length. Additionally, the BTH acknowledgement field is set to “true”.

As such, at 632, the target 620 sends an acknowledgement and at 634, RDMA “write first” packet, to the initiator 610, via the switch fabric 500. In the RDMA “write first” packet, the RETH rkey matches the rkey of the “send only” packet and the BTH acknowledgement is set to “false”. Based on the CID, the “send only” is matched with the “write first” and the RDMA engine 140 computes a read initiation time value 650 (total read initiation time of the time metrics 434 in FIG. 4B).

The storage read input and output transaction 600 further involves at 636, the target 620 sending one or more RDMA “write middle” packets to the initiator 610 via the switch fabric 500. In these RDMA “write middle” packets, the PSN is incremented and the acknowledgement is set to “false”. At 638, the target 620 sends RDMA “write last” packet to the initiator 610 via the switch fabric 500. In this RDMA “write last” packet, the acknowledgement is set to “true”. As such, at 640, the initiator 610 sends an acknowledgement packet to the target 620 via the switch fabric 500. In this acknowledgement packet, the PSN matches the PSN of the RDMA “write last” packet. The RDMA engine 140 computes the number of packets from the RDMA “write first” packet to the RDMA “write last” packet by dividing the DMA length by the maximum transmission unit (MTU).

At 642, the initiator 610 sends a “send only” packet with invalidate or just a “send only” packet to the target 620 via the switch fabric 500. The “send only” packet includes the payload with a CID that matches the CID of the “send only” packet at 630. Further, the Invalidate Extended Transport Header (IETH) rkey matches the rkey of the “send only” packet at 630. Additionally, the PSN of the “send only” packet at 642 matches the PSN of the RDMA “write last” packet at 638. The acknowledgement in the “send only” packet is set to “true”. Based on these values, the RDMA engine 140 computes a read acknowledgement time 652 and a read completion time 654 (such as the time metrics 434 in FIG. 4B).

At 644, the initiator 610 sends an acknowledgment packet of the “send only” packet with invalidate to the target 620 via the switch fabric 500. In this acknowledgement packet, the BTH. PSN matches the PSN of the “send only” packet with invalidate at 642. The entry for this RDMA data flow is then deleted from the opcode table 320. Since the opcode table maintains an operation state of an RDMA storage transaction, the entry is flushed from the opcode table 320 when the RDMA storage transaction is complete, for example, based on the acknowledgement packet at 644.

Turning now to FIG. 6B, FIG. 6B is a sequence diagram illustrating a storage write input and output transaction 660 from the initiator 610 to the target 620 via the switch fabric 500 for which RDMA level metrics are computed, according to an example embodiment. The storage write input and output transaction 660 may be a block storage NVMe/RoCE write I/O transaction.

The storage write input and output transaction 660 starts at 662, the initiator 610 sends a “send only” packet to the target 620 via the switch fabric 500. The “send only” packet includes a payload opcode “write” and a payload CID. The BTH header includes the DestQP and PSN. The payload may further include the virtual address, the rkey, and the DMA length.

At 664, the target 620 sends an RDMA read request to the initiator 610 via the switch fabric 500. In the RDMA read request, the RETH virtual address, the rkey, and the DMA length matches these values in the “send only” packet at 662. The BTH acknowledgement is set to “true”. Based on the foregoing, the “send only” packet at 662 is matched with the RDMA read request and the RDMA engine 140 computes the write initiation time 680 (the write initiation time of the time metrics 434 in FIG. 4B).

The storage write input and output transaction 660 further involves at 666, the initiator 610 sending RDMA “read response first” to the target 620 via the switch fabric 500. The RDMA “read response first” packet has the PSN that matches the PSN of the read request at 664. The AETH. syndrome is set to acknowledgement (in response to the BTH acknowledgement set to “true” at 664). At 668, the initiator 610 sends one or more of RDMA “read response middle” packets to the target 620 via the switch fabric 500. The PSN is incremented with each transmitted RDMA “read response middle” packet. At 670, the initiator 610 sends a RDMA “read response last” packet to the target 620 via the switch fabric 500. The AETH. sydrome is set to acknowledgment. The RDMA engine 140 computes the number of packets 682 (total number of writes of the basic metrics 430 in FIG. 4B). For example, the DMA length is divided by the maximum transmission unit (MTU) to compute the number of packets from the RDMA “read response first” at 666 to the RDMA “read response last” at 670.

The storage write input and output transaction 660 completes at 672, with the target 620 sending a “send only” with invalidate or a “send only” packet to the initiator 610 via the switch fabric 500. The “send only” packet includes a CID that matches the CID of the “send only” packet at 662. Additionally, the IETH. rkey matches the rkey of the “send only” packet at 662. Based on the bi-directional matching of the “send only” packets at 662 and at 672, the RDMA engine 140 computes total write acknowledgement time 684 and time data copied to memory such as a total write completion time 686 (the time metrics 434 in FIG. 4B).

In short, in the I/O storage transactions, CID and PSN fields may be the flow matching criteria 350 of FIG. 3. The CID matches RDMA requests and responses at the RDMA transaction level.

In one example embodiment, based on identifying the context of an RDMA data flow to be a file storage transaction, a transaction ID field may be used for matching remote procedure call (RPC) requests and responses, for example, for file a storage network file storage (NFS) over RDMA.

In another example embodiment, ultra ethernet transport (UET) protocol may be used as an alternative to RoCEv2. The RDMA engine 140 inspects or parses the ultra ethernet transport (UET) header for identifiers that link the RDMA request with the corresponding RDMA response (such as transaction identifiers, matching keys, etc.). The flow matching criteria 350 may be identifiers of the UET header field such as transaction identifiers.

Based on these RDMA level metrics, troubleshooting operations of a networking environment may be improved and network problems may be resolved by providing visibility into RDMA transactions.

Referring back to FIG. 1, the Day2Ops platform 150 may obtain the RDMA level metrics computed by various RDMA engines via the network and perform RDMA specific troubleshooting. The RDMA flow tables may be periodically streamed from switch software to the Day2Ops platform 150. The Day2Ops platform 150 stores historical telemetry data in a data lake for various visualizations, trend analysis, and for running various machine learning (ML)/AI algorithms for deeper insights.

Some visualization examples for Inter-GPU RDMA metrics context may be as follows. The RDMA engines capture opcode level metrics at leaf switch edge ports. The RDMA engines may track the RoCEv2 flow tuples <Port, VLAN, SIP, DIP, QPs>, and for each flow, collect send, read, write metrics, a count value for the number of NACKs to track packet loss/errors and a count value for the CNPs indicative of congestion (such as the flow metrics list 400 in FIG. 4A). These RDMA metrics may then be applied to determine network problems such as an imbalance in a GPU load distribution, GPUs having highest/lowest traffic rate (packet loss), Top-N GPUs in terms of RDMA latency (slowest GPU), and/or GPUs with highest and lowest throughput (stuck GPU). The Day2Ops platform 150 may correlate CNPs with interface metrics (PFC, packet drops) for deeper insights.

Some visualization examples for storage RDMA metrics context may be as follows. The RDMA engines monitor host to storage traffic and identify I/O boundaries based on NVMe/RoCE specification. The RDMA I/O transaction metrics are captured at leaf switch edge ports. Specifically, the RoCEv2 storage flow tuples <Port, VLAN, SIP, DIP, QPs> are tracked and for each flow, read I/O metrics, write I/O metrics, and I/O errors are collected (flow metrics list 420 in FIG. 4B). The Day2Ops platform 150 may then detect network problems, identify I/O Top-Talkers, generate Read/Write I/O latency baselining, perform anomaly detection, perform root causation (Host/Storage/Network) of I/O performance issues, deeper congestion analysis in conjunction with interface metrics, based on these RDMA transaction level metrics.

Additionally, in one or more example embodiments, the Day2Ops platform 150 may perform deeper troubleshooting and anomaly detections based on the generated RDMA metrics. For example, RDMA inter-GPU traffic for a parallel job exhibits a lot of symmetry, where the rankings of a job perform similar a set of actions over the network simultaneously. As such, if there is one job that is performing a different set of RDMA operations or experiencing different latency, the GPUs that are exhibiting the problem are identified. As another example, for RDMA storage traffic, an identification may be made whether the bottleneck is in the sender, the receiver, or an intermediate network device based on a correlation of the computed RDMA I/O transaction completion time and RDMA I/O transaction initiation time. As yet another example, the correlation of CNP packets to data rates may help identify congestion and associated recovery actions. A continuous presence of CNP may mean persistent congestion that may eventually translate into a Priority Flow Control (PFC) being asserted in the switch fabric. Proactive warnings based on CNPs may be generated before the PFC.

In one or more example embodiments, the Day2Ops platform 150 may provide proactive alerts and cause reconfiguration actions based on RDMA level metrics. For example, tracking number of active RDMA flows may help in proactive alerting. A large number of open connections (e.g., greater than 200) may be seen to cause 90% request rate drop on some NIC models. As another example, errors carried in NACK reason codes may stall RNIC processing units in one direction and potentially hang applications. Some examples are a transport timeout (the responder side does not send an ACK or a NACK), a receive not ready (RNR) error in which the responder does not have enough receive requests for arriving send requests, a protection error, which means the posted request does not reference a valid local or remote memory region, and/or an operation error, which means the opcode is operated on the wrong type of QP. Moreover, error codes may indicate that complex verbs consume more RNIC resources e.g., ATOMIC and READ operations are also more expensive than SEND and WRITE. As such, a NIC performing more READS than WRITEs may exhibit lower performance for the same amount of RDMA data transfers. As yet another example, PCIe bandwidth connected to the GPU/CPU may become the bottleneck when the request size is in a specific range. An analysis of the RDMA data transfer size may help identify these network issues and reconfigure one or more devices to resolve the problem.

These are just some non-limiting examples of troubleshooting based on RDMA level metrics. Other reconfigurations, troubleshooting, etc. may be performed based on the RDMA level metrics generated by the RDMA engines.

Collecting and computing RDMA metrics by the RDMA engines may be advantageous in various ways. For example, it is scalable for the Day2Ops platform 150 to integrate with fewer switches, rather than a large number of NICs. That is, there is a single method of telemetry data receiver integration with fewer integration touch points. Also, switches are usually more reliable compared to NICs. Further, RDMA level metrics from the switches may identify endpoint devices that are stuck/slow with respect to RDMA traffic. Additionally, switches with a programmable ASIC or DPU may be configured to capture various types of RDMA profiles in a generic fashion like inter-GPU, block/file storage, etc. Moreover, switch interface metrics and RDMA metrics from the same switch help in easy correlations. For example, a switch PFC event impacting RDMA transactions may be readily confirmed by correlating timestamps of these two telemetry metrics from a switch.

In one example embodiment, a node or an endpoint device may be dual homed and connected to two (or more) leaf switches in active-active mode. As such, RDMA traffic flow with the same IP address may be sent along two different paths. In this instance, bi-directional matching may be hindered for requests and responses that arrive at different active leaf switches. The RDMA engine 140 may then be configured to aggregate and average one or more RDMA telemetry metrics and implement a timeout for the opcode table 320 of FIG. 3.

With continued reference to FIGS. 1-3, 4A, 4B, 5A, 5B, 5C, 6A, and 6B, FIG. 7 is a diagram illustrating an environment 700 in which an RDMA engine is deployed for dual homed endpoint devices, according to another example embodiment. The environment 700 includes the first leaf switch 120a, the second leaf switch 120b, the spine switch 130 of the FIG. 1. The environment 700 further includes a first dual homed endpoint device 710a and a second dual homed endpoint device 710b.

For example, a RDMA request 720 from the first dual homed endpoint device 710a is serviced by the first leaf switch 120a and a RDMA response 730 is provided from the second leaf switch 120b. Since the first dual homed endpoint device 710a and the second dual homed endpoint device 710b are serviced by both switches, there is no guarantee that the request and the response arrive on the same switch. As such, a match in the opcode table 320 of FIG. 3 may not always be possible. Accordingly, the RDMA engine 140 is configured to flush out entries from the opcode table 320 after a predetermined timeout because some of the responses may not be received. Additionally, the RDMA engine 140 is configured to compute average latency related metrics based on a sample rate of matched transactions and aggregate certain RDMA metric values from multiple switch devices.

As an example, the RDMA engine 140 may perform the following RDMA level metrics computations. First, basic RDMA metrics for a SIP, DIP, QP are computed by aggregating RDMA flow metrics from more than one switch/port in the Day2Ops platform 150 of FIG. 1, for example. That is, the Day2Ops platform 150 may obtain RDMA information from the first leaf switch 120a and the second leaf switch 120b and perform the RDMA level metrics computations. If a NIC of the first dual homed endpoint device 710a originates 10 RDMA writes and five of these RDMA writes are services by the first leaf switch 120a and the other five of these RDMA writes are serviced by the second leaf switch 120b, the total RDMA write metric for a SIP, DIP, QP is computed by adding the metrics from the first leaf switch 120a and the second leaf switch 120b. Second, there is only a 50% chance that a request and a corresponding response arrive at the same leaf switch. As such, for the RDMA latency metrics, the RDMA engine 140 computes average values for the matched RDMA requests and responses. That is, a 50% sampling rate may be sufficient to compute an average RDMA completion latency.

As noted above, entries from the opcode table 320 that are not completed within a predetermined time period are flushed based on a timeout. In short, the RDMA engine 140 flushes unmatched entries in opcode table 320 based on a preset timeout value.

In one or more example embodiments, it is assumed that the UDP Payload (BTH header) is in the clear (unencrypted). In highly secure environments where layer 4 (L4) data is encrypted, computing metrics may not be possible. However, a majority of enterprise AI deployments may not enable packet-by-packet encryption for performance reasons. RDMA metrics may be enabled in these environments.

Using an ASIC embedded programmable RDMA engine, a data center switch may generate metrics for various types of RDMA data flows passing through the switch resulting in a RDMA metrics solution for an RoCEv2 fabric and/or UET fabric. This is useful to build a simplified RDMA Day2Ops receiver platform with no dependency on endpoint devices. RDMA level metrics (even averaged and aggregated values) are useful for visualization, trending, and anomaly detection of RDMA data flows.

The techniques presented herein provide an ASIC embedded or an onboard DPU assisted programmable RDMA engine configured to perform generic RDMA telemetry data collection (at a central entity such as a switch fabric). The RDMA engine provides visibility into various types of RDMA messages. The engine collects metrics for RDMA traffic passing through a central entity such as a leaf switch. An ASIC in a switch may apply the ACL feature to examine RDMA data flows of interest and specific RDMA packets (a first packet, a last packet, acknowledgment (ACK) packets, and negative acknowledgment (NACK) packets). The RDMA engine computes RDMA level metrics such as number of transactions, data transfer sizes, latency, and error metrics. The RDMA level metrics are computed based on bi-directional matching of RDMA request and response frames in a data path for every RDMA data flow.

In one or more example embodiments, the RDMA engine performs bi-directional matching using at least two hash tables such as a flow table for storing generated RDMA level metrics and an opcode table for bi-directional matching of requests and responses in an RDMA data flow based on a matching criteria, which varies depending on the RDMA context. An entry is created in a flow table when a first data packet for a RDMA tuple is seen on a port. The opcode table is per-flow per-outstanding opcode with the tuple and a match key (identifiers), as the key. Every entry is a child of an entry in the flow table. The match key is a variable length field that matches an opcode, PSN, rkey, CID, etc., depending on the context of the RDMA data flow (inter-GPU or I/O storage transaction). The opcode table is an ephemeral table that maintains the state for transactions/messages that are in transit. As the RDMA operation starts, an entry is created in the opcode table and as the RDMA operation completes, the entry is flushed and generated RDMA level metrics are aggregated in the corresponding parent flow table entry.

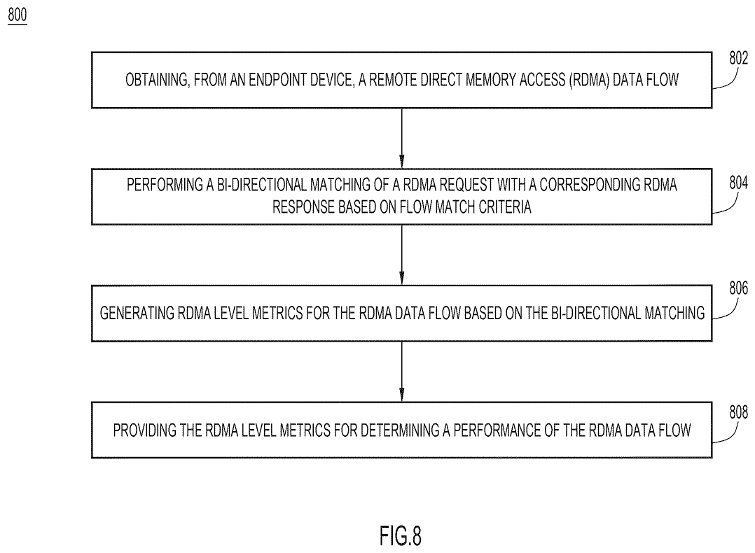

Turing now to FIG. 8, FIG. 8 is a flowchart illustrating a method 800 of providing RDMA level metrics for determining a performance of RDMA data flow that is generated based on bidirectional matching of RDMA requests with corresponding responses, according to an example embodiment. The method 800 may be performed by an RDMA engine in a network device such as a leaf switch or in a DPU, examples of which are shown in FIGS. 10A and 10B.

The method 800 involves, at 802, obtaining, from an endpoint device, a remote direct memory access (RDMA) data flow.

Additionally, the method 800 further involves, at 804, performing a bi-directional matching of an RDMA request with a corresponding RDMA response based on flow match criteria.

Moreover, the method 800 further involves, at 806, generating RDMA level metrics for the RDMA data flow based on the bi-directional matching and, at 808, providing the RDMA level metrics for determining a performance of the RDMA data flow.

In one form, the method 800 may further involve inspecting one or more packets of the RDMA data flow to determine a packet of interest for the bi-directional matching. The operation 804 of performing the bi-directional matching of the RDMA request with the corresponding RDMA response may involve identifying at least one field in a header of a plurality of packets of the RDMA data flow that includes at least one identifier of the flow match criteria.

In one instance, the method 800 may further involve a data processing unit obtaining the packet of interest. The bi-directional matching of the RDMA request with the corresponding RDMA response may be performed by the data processing unit.

In one instance, the operation 804 of performing the bi-directional matching of the RDMA request with the corresponding RDMA response may further involve generating an entry for the RDMA data flow in each of a first table and a second table. The entry may include a source address, a destination address, and a port, as the at least one identifier. The operation 804 of performing the bi-directional matching of the RDMA request with the corresponding RDMA response may further involve flushing the entry from the first table and adding the RDMA level metrics to the entry in the second table, based on identifying the corresponding RDMA response.

In another instance, the operation 804 of performing the bi-directional matching of the RDMA request with the corresponding RDMA response may further involve maintaining an operation state of an RDMA message or a transaction state of an RDMA transaction in a first hash table based on the at least one identifier and storing the RDMA level metrics in a second hash table based on the operation state or the transaction state being complete.

In one or more example embodiments, the operation of identifying the at least one field in the header of the plurality of packets of the RDMA data flow may involve inspecting an ultra ethernet transport (UET) header for the at least one identifier that links the RDMA request with the corresponding RDMA response.

In another form, the method 800 may further involve determining a context of the RDMA data flow. The context is one of an inter graphics processing unit (GPU) transaction or a storage transaction. The method 800 may further involve, based on the context being the inter-GPU transaction, generating the RDMA level metrics at an RDMA message level and based on the context being the storage transaction, generating the RDMA level metrics at an input and output RDMA transaction level.

In one instance, the operation 806 of generating the RDMA level metrics for the RDMA data flow may involve generating one or more latency related metrics, one or more basic metrics, and one or more error metrics, based on the context of the RDMA data flow.

In one or more example embodiments, the method 800 may further involve performing a troubleshooting operation of a networking environment based on the one or more error metrics including a count value for receiving a negative acknowledge packet of the RDMA data flow.

In yet another form, the method 800 may further involve determining a network problem based on a reason code in each negative acknowledgement packet of the RDMA data flow and changing a configuration of a networking environment to resolve the network problem.

In one or more example embodiments, the endpoint device is serviced by the network device and at least one other network device. The operation 806 of generating the RDMA level metrics for the RDMA data flow may involve computing an average RDMA completion latency based on a set of RDMA requests that are matched with corresponding RDMA responses of the RDMA data flow based on the flow match criteria.

FIG. 9 is a hardware block diagram of a computing device 900 that may perform functions associated with any combination of operations in connection with the techniques depicted in FIGS. 1-3, 4A, 4B, 5A, 5B, 5C, 6A, 6B, 7, and 8 according to various example embodiments, including, but not limited to, operations of an apparatus such as endpoint device, a client device, a computing device or one or more servers that execute RDMA operations and/or deploy the Day2Ops platform 150 of FIG. 1. It should be appreciated that FIG. 9 provides only an illustration of one example embodiment and does not imply any limitations with respect to the environments in which different example embodiments may be implemented. Many modifications to the depicted environment may be made.

In at least one embodiment, computing device 900 (an apparatus) may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various example embodiments, instructions associated with logic for computing device 900 can overlap in any manner and are not limited to the specific allocation of instructions and/or operations described herein.

In at least one example embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one example embodiment, one or more memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with one or more memory elements 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various example embodiments, network processor unit(s) 910 may enable communication between computing device 900 and other systems, entities, etc., via network I/O interface(s) 912 to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, and/or any other I/O port(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a display 916 such as a computer monitor, a display screen, or the like.

In various example embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 906 and/or memory elements(s) 904 can store data, software, code, instructions (e.g., processor instructions), logic, parameters, combinations thereof, and/or the like used for operations described herein. This includes the storage 906 and/or memory elements(s) 904 being able to store data, software, code, instructions (e.g., processor instructions), logic, parameters, combinations thereof, or the like that are executed to carry out operations in accordance with teachings of the present disclosure.

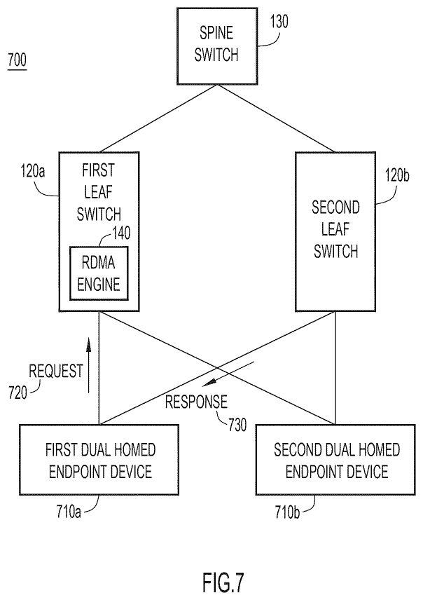

FIGS. 10A and 10B are hardware block diagrams illustrating device(s) that may perform functions associated with any combination of operations in connection with the techniques depicted and described in FIGS. 1-3, 4A, 4B, 5A, 5B, 5C, 6A, 6B, 7, and 8, according to various example embodiments. Specifically, FIGS. 10A and 10B illustrate a network device 1000, according to various example embodiments. In FIG. 10A, the network device 1000 includes an RDMA engine that generates RDMA level metrics based on bi-directional matching and in FIG. 10B, a data processing unit 1050 is connected to the network device 1000 and includes the RDMA engine. Some examples of the device(s) are the first leaf switch 120a, the second leaf switch 120b of FIGS. 1 and 7, or a leaf switch in the switch fabric 500 of FIGS. 5A, 5B, 5C, 6A, and 6B. The network device 1000 is an apparatus configured to forwards packets in a network.

In FIGS. 10A and 10B, the network device 1000 includes an ingress interface 1002, a hardware memory 1010 that includes a buffer pool 1012 for RDMA queues, a CPU 1020, and an egress interface 1030. The ingress interface 1002 connects the network device 1000 to one or more endpoint devices via a downlink 1040 and the egress interface 1030 connects the network device 1000 to a spine leaf (not shown) via an uplink 1042.

The ingress interface 1002 includes one or more ports. The ingress interface 1002 is configured to receive RDMA packets of various traffic flows such as an incoming RDMA data flow from endpoint devices such as servers and/or storage devices, via the downlink 1040. Additionally, the ingress interface 1002 is configured to transmit RDMA packets of various traffic flows to the endpoint devices, via the downlink 1040. The ingress interface 1002 places the RDMA packets in the buffer pool 1012 of the memory 1010 for processing. That is, the buffer pool 1012 that store the RDMA packets while various lookup operations and processing are performed at the network device 1000.

When the processing is complete, the RDMA packets may be provided to the egress interface 1030. The egress interface 1030 includes one or more ports. The egress interface 1030 is configured to transmit the RDMA data packets to their next hop in the switch fabric (the spine switch) via the uplink 1042.

The memory 1010 may include read only memory (ROM) of any type now known or hereinafter developed, random access memory (RAM) of any type now known or hereinafter developed, magnetic disk storage media devices, tamper-proof storage, optical storage media devices, flash memory devices, electrical, optical, or other physical/tangible memory storage devices. In general, the memory 1010 may comprise one or more tangible (non-transitory) computer readable storage media (e.g., a memory device) encoded with software comprising computer executable instructions and when the software is executed (by the CPU 1020) it is operable to perform certain network device operations described herein. That is, the memory 1010 stores various instructions that are to be performed by the CPU 1020.

The CPU 1020 executes instructions associated with software stored in memory 1010. Specifically, the memory 1010 stores instructions for control logic that, when executed by the CPU 1020, causes the CPU 1020 to perform various operations on behalf of the network device 1000 as described herein. The memory 1010 may also store configuration information received from a network controller to configure the network device 1000 according to desired network functions. In some example embodiments, the CPU 1020 may be a microprocessor or a microcontroller.

It should be noted that RDMA operations described in one or more example embodiment are performed without involving CPUs of endpoint devices.

It should be noted that in some example embodiments, the control logic may be implemented in the form of firmware implemented by one or more ASICs.

The CPU 1020 may include packet processing logic such as switch tables, switch fabric that operate to determine whether to drop, forward (and via a particular egress port), switch, etc. a particular packet based on contents in the header of the packet. One or more Application Specific Integrated Circuits (ASICs) may implement the packet processing logic.

In FIG. 10A, the network device 1000 includes an RDMA engine 1004 (such as the RDMA engine 140 of FIGS. 1 and 7) and hash tables 1014 for bi-directional matching and RDMA level metrics.

Specifically, the RDMA engine 1004 performs bi-directional matching of RDMA requests with corresponding RDMA responses based on flow match criteria. The flow match criteria includes identifiers such as packet sequence number (PSN), command identifier (CID), etc. Based on this match, the RDMA engine 1004 generates RDMA level metrics for the RDMA data flow. The bi-directional matching is performed using hash tables 1014 such as the flow table and the opcode table of FIG. 3. The generated RDMA level metrics is stored in these hash tables 1014. These hash tables 1014 include an opcode table, the opcode table is one level below the flow table as shown in FIG. 3. The RDMA engine 1004 is in the middle and equally accessible from the ingress interface 1002 and the egress interface 1030. The RDMA engine 1004 accesses the hash tables 1014 stored in the memory 1010 and stores RDMA level metrics in the memory 1010. This is just one example.

In another example embodiment shown in FIG. 10B, a DPU based scheme is deployed where the ingress interface 1002 and the egress interface 1030 forward data path packets of interest to an on-board DPU 1050, which is external to the ASIC or the network device 1000. The DPU 1050 is configured to host an RDMA engine 1004′ and a memory that stores hash tables 1014′ for bi-directional matching and for computing metrics. In FIG. 10B, the RDMA engine 1004′ and the hash tables 1014′ are external to the ASIC (the network device 1000). As such, the network device 1000 forward the RDMA data flow (packets of interest) to the DPU 1050.

In another example embodiment, an apparatus is provided. The apparatus includes a network interface configured to enable network communications and a processor. The processor is configured to perform operations including obtaining, from an endpoint device, a remote direct memory access (RDMA) data flow and performing a bi-directional matching of a RDMA request with a corresponding RDMA response based on flow match criteria. The processor is further configured to perform additional operations that include generating RDMA level metrics for the RDMA data flow based on the bi-directional matching and providing the RDMA level metrics for determining a performance of the RDMA data flow.

In yet another example embodiment, one or more non-transitory computer readable storage media encoded with instructions are provided. When the media is executed by a processor, the instructions cause the processor to perform operations that include obtaining, from an endpoint device, a remote direct memory access (RDMA) data flow and performing a bi-directional matching of a RDMA request with a corresponding RDMA response based on flow match criteria. The computer readable storage media encoded with instructions that may further cause the processor to perform additional operations that include generating RDMA level metrics for the RDMA data flow based on the bi-directional matching and providing the RDMA level metrics for determining a performance of the RDMA data flow.

In yet another example embodiment, a system is provided that includes the devices and operations explained above with reference to FIGS. 1-3, 4A, 4B, 5A, 5B, 5C, 6A, 6B, 7-9, 10A, and 10B.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
obtaining, by a network device from an endpoint device, a remote direct memory access (RDMA) data flow;
performing a bi-directional matching of a RDMA request with a corresponding RDMA response based on flow match criteria;
generating RDMA level metrics for the RDMA data flow based on the bi-directional matching; and
providing the RDMA level metrics for determining a performance of the RDMA data flow.

2. The method of claim 1, further comprising:
inspecting one or more packets of the RDMA data flow to determine a packet of interest for the bi-directional matching,
wherein performing the bi-directional matching of the RDMA request with the corresponding RDMA response includes identifying at least one field in a header of a plurality of packets of the RDMA data flow that includes at least one identifier of the flow match criteria.

3. The method of claim 2, further comprising:
obtaining, by a data processing unit, the packet of interest,
wherein the bi-directional matching of the RDMA request with the corresponding RDMA response is performed by the data processing unit.

4. The method of claim 2, wherein performing the bi-directional matching of the RDMA
request with the corresponding RDMA response further includes:
generating an entry for the RDMA data flow in each of a first table and a second table, wherein the entry includes a source address, a destination address, and a port, as the at least one identifier; and
flushing the entry from the first table and adding the RDMA level metrics to the entry in the second table, based on identifying the corresponding RDMA response.

5. The method of claim 2, wherein performing the bi-directional matching of the RDMA
request with the corresponding RDMA response further includes:
maintaining an operation state of an RDMA message or a transaction state of an RDMA transaction in a first hash table based on the at least one identifier; and
storing the RDMA level metrics in a second hash table based on the operation state or the transaction state being complete.

6. The method of claim 2, wherein identifying the at least one field in the header of the
plurality of packets of the RDMA data flow includes:
inspecting an ultra ethernet transport (UET) header for the at least one identifier that links the RDMA request with the corresponding RDMA response.

7. The method of claim 1, further comprising:
determining a context of the RDMA data flow, wherein the context is one of an inter graphics processing unit (GPU) transaction or a storage transaction;
based on the context being the inter GPU transaction, generating the RDMA level metrics at an RDMA message level; and
based on the context being the storage transaction, generating the RDMA level metrics at an input and output RDMA transaction level.

8. The method of claim 7, wherein generating the RDMA level metrics for the RDMA data flow includes:
generating one or more latency related metrics, one or more basic metrics, and one or more error metrics, based on the context of the RDMA data flow.

9. The method of claim 8, further comprising:
performing a troubleshooting operation of a networking environment based on the one or more error metrics including a count value for receiving a negative acknowledge packet of the RDMA data flow.

10. The method of claim 8, further comprising:
determining a network problem based on a reason code in each negative acknowledgement packet of the RDMA data flow; and
changing a configuration of a networking environment to resolve the network problem.

11. The method of claim 1, wherein the endpoint device is serviced by the network device and at least one other network device and wherein generating the RDMA level metrics for the RDMA data flow includes:
computing an average RDMA completion latency based on a set of RDMA requests that are matched with corresponding RDMA responses of the RDMA data flow based on the flow match criteria.

12. An apparatus comprising:
a network interface to receive and send packets in a network; and
a processor, wherein the processor is configured to perform operations comprising:
obtaining, from an endpoint device, a remote direct memory access (RDMA) data flow;
performing a bi-directional matching of a RDMA request with a corresponding RDMA response based on flow match criteria;
generating RDMA level metrics for the RDMA data flow based on the bi-directional matching; and
providing the RDMA level metrics for determining a performance of the RDMA data flow.

13. The apparatus of claim 12, wherein the processor is configured to perform the bi-directional matching of the RDMA request with the corresponding RDMA response by:
identifying at least one field in a header of a plurality of packets of the RDMA data flow that includes at least one identifier of the flow match criteria.

14. The apparatus of claim 13, wherein the processor is configured to perform the bi-directional matching of the RDMA request with the corresponding RDMA response further by:
generating an entry for the RDMA data flow in each of a first table and a second table, wherein the entry includes a source address, a destination address, and a port, as the at least one identifier; and
flushing the entry from the first table and adding the RDMA level metrics to the entry in the second table, based on identifying the corresponding RDMA response.

15. The apparatus of claim 13, wherein the processor is configured to perform the bi-directional matching of the RDMA request with the corresponding RDMA response further by:
maintaining an operation state of an RDMA message or a transaction state of an RDMA transaction in a first hash table based on the at least one identifier; and
storing the RDMA level metrics in a second hash table based on the operation state or the transaction state being complete.

16. The apparatus of claim 13, wherein the processor is configured to identify the at least one field in the header of the plurality of packets of the RDMA data flow by:
inspecting an ultra ethernet transport (UET) header for the at least one identifier that links the RDMA request with the corresponding RDMA response.

17. The apparatus of claim 12, wherein the processor is further configured to perform additional operations comprising:
determining a context of the RDMA data flow, wherein the context is one of an inter graphics processing unit (GPU) transaction or a storage transaction;
based on the context being the inter GPU transaction, generating the RDMA level metrics at an RDMA message level; and
based on the context being the storage transaction, generating the RDMA level metrics at an input and output RDMA transaction level.

18. One or more non-transitory computer readable storage media encoded with software comprising computer executable instructions that, when executed by a processor, cause the processor to perform operations including:
obtaining, from an endpoint device, a remote direct memory access (RDMA) data flow;
performing a bi-directional matching of a RDMA request with a corresponding RDMA response based on flow match criteria;
generating RDMA level metrics for the RDMA data flow based on the bi-directional matching; and
providing the RDMA level metrics for determining a performance of the RDMA data flow.

19. The one or more non-transitory computer readable storage media according to claim 18, wherein the computer executable instructions cause the processor to perform the bi-directional matching of the RDMA request with the corresponding RDMA response by:
identifying at least one field in a header of a plurality of packets of the RDMA data flow that includes at least one identifier of the flow match criteria.

20. The one or more non-transitory computer readable storage media according to claim 19, wherein the computer executable instructions cause the processor to perform the bi-directional matching of the RDMA request with the corresponding RDMA response further by:
generating an entry for the RDMA data flow in each of a first table and a second table, wherein the entry includes a source address, a destination address, and a port, as the at least one identifier; and
flushing the entry from the first table and adding the RDMA level metrics to the entry in the second table, based on identifying the corresponding RDMA response.
